(19) United States
(12) Patent Application Publication
(10) Pub. No.: US 2021/0132630 A1
(43) Pub. Date: May 6, 2021

(54) A METHOD FOR AT LEAST ONE STRING OF PLATOONING VEHICLES

(71) Applicant: VOLVO TRUCK CORPORATION, Göteborg (SE)

(72) Inventors: Stefan Bergquist, Göteborg (SE); Wilhelm Wiberg, Askim (SE)

(21) Appl. No.: 16/478,229

(22) PCT Filed: Jan. 24, 2017
(86) PCT No.: PCT/EP2017/051375

§ 371 Date: Jul. 16, 2019

(51) Int. Cl. G05D 1/02; G08G 1/00; B60W 30/165

(52) U.S. Cl. CPC G05D 1/0293; G05D 1/0295; G05D 2201/0213; B60W 30/165; G08G 1/22

(57) ABSTRACT

The invention relates to a method for at least one string, each string comprising a plurality of vehicles platooning by means of vehicle-to-vehicle communication, characterized by a vehicle (VIDY) in a string (SID1) repeatedly or continuously transmitting (S1) string and vehicle data including a roof value (MAXnX) representing a maximum number of vehicles allowed in the string, and a participation value (POSn) indicative of the current number of vehicles in the string (SID1).

### TECHNICAL FIELD

The invention relates to a method for at least one string, each string comprising a plurality of vehicles platooning by means of vehicle-to-vehicle communication. The invention also relates to a method for a subject vehicle in a string comprising a plurality of vehicles platooning by means of vehicle-to-vehicle communication. The invention also relates to a computer program, a computer readable medium, a control unit and a vehicle.

The invention can be applied in heavy-duty vehicles, such as trucks, buses and construction equipment. Although the invention will be described with respect to trucks, the invention is not restricted to this particular vehicle, but may also be used in other vehicles such as cars.

### BACKGROUND

In platooning, e.g. by means of Cooperative Adaptive Cruise Control (CACC), vehicle convoys are driven with short distances between the vehicles. To achieve this with a high safety, a control unit of each vehicle receives information from surrounding vehicles over a wireless communication channel, so called Vehicle-to-Vehicle (V2V) communication. This information is used in the control to keep the desired distance between each vehicle and the immediately preceding vehicle and to handle events such as hard braking. The V2V communication enables keeping short distances safely since the V2V information is transferred much faster and is more accurate than data from on-board sensors such as radar sensors, laser sensors or cameras.

Benefits with platooning, e.g. by CACC, include increased fuel efficiency, provided by a reduced air-drag due to short distances between vehicles, and provided by improved vehicle control due to more accurate information about the preceding vehicle.

A further benefit is an improved traffic flow due to the small delay of the V2V data. For example, the traffic flow may be improved by reducing or eliminating the so called rubber-band effect between vehicles. Such an effect may appear due to the delay of a detection by a vehicle of a deceleration of a preceding vehicle, causing a stronger deceleration of the detecting vehicle, upon which a delay of a detection by a following vehicle of the stronger deceleration causing an even stronger deceleration of the following vehicle, and so on. In CACC based control the rubber band effect will be considerably reduced due to the decreased delay, and due to a detecting vehicle being able to take into account signals from vehicles in front of the immediately preceding vehicle.

Yet another benefit with CACC and platooning is an improved driver comfort since CACC allows less aggressive vehicle control compared to systems using on-board sensors exclusively.

Notwithstanding said benefits, there is still room for improvement of known CACC and other platooning strategies. In particular solutions for forming, changing and maintaining strings of platooning vehicles may be improved. When handling a string, the maximum number of vehicles in a string may have to be considered. Such a maximum number may be due to avoiding strings being too long so as to interfere with other traffic, or to avoid communication problems within the strings.

US2013261948 discloses a vehicle-to-vehicle communication solution where, in a convoy joining process, a convoy joining request is transmitted from a vehicle to a vehicle in the convoy. A permission signal may then be received from the vehicle in the convoy. The permission signal is dependent on whether the number of vehicles traveling in the convoy is equal to a maximum capacity. If the requesting vehicle is permitted to join the convoy, vehicles traveling in the convoy are informed that the requesting vehicle has joined the convoy and they are also informed of the vehicle identity of the joining vehicle. Such a process involves a relatively large number of steps, and increases the bandwidth needed for the V2V communication and/or makes the process relatively slow.

### SUMMARY

An object of the invention is to improve solutions for forming, changing and maintaining strings of platooning vehicles. A further object of the invention is to simplify processes for forming, changing and maintaining strings of platooning vehicles.

The objects are reached by a method according to claim 1. Thus, the invention provides a method for at least one string, each string comprising a plurality of vehicles platooning by means of vehicle-to-vehicle communication, the method comprising a vehicle in a string repeatedly or continuously transmitting string and vehicle data including a roof value representing a maximum number of vehicles allowed in the string, and a participation value indicative of the current number of vehicles in the string.

It is understood that the V2V communication may involve controlling the velocity and/or acceleration of a vehicle the string in dependence on the signals received from another vehicle in the string. The string may be formed of a row of vehicles, one following another.

The invention provides for vehicles not participating in the string determining based solely on the string and vehicle data whether it is possible to join the string. I.e. there is no need for any request to join the string to be send from the non-participating vehicle to a vehicle in the string. Further vehicles in the string do not have to be informed about whether or not any further vehicle joins the string. This reduces compared to known art the number of steps involved in a string joining process of a vehicle. Thereby, the string handling process is simplified, and the bandwidth requirements of the V2V communication may be reduced.

The vehicle transmitting the string and vehicle data may be the last vehicle in the string, and the participation value may be a position value representing a position in the string of the last vehicle in the string. Where the string comprises a lead vehicle at the front of the string, the participation value may represent a position in the string, counting from the lead vehicle, of the last vehicle in the string. Thereby, the position value of the last vehicle in the string may serve the dual purpose of indicating the position of the last vehicle in the string and to indicate to vehicles intending to join the string the number of vehicles participating in the string. Thereby, the participation value does not have to be communicated within the string. Rather, by each vehicle in the string determining its respective position value, enough information may be provided for a non-participating vehicle determining whether it can join the string. However, in some embodiments, the participation value may be communicated to all vehicles in the string.

The string and vehicle data may be sent at least once per second, e.g. 10-20 times per second. Thereby it is secured that a non-participating vehicle determining whether it can join the string obtains current information for this determination. More specifically, current information about the number of vehicles in the string, and the maximum number of vehicles allowed in the string, is secured.

Preferably the method comprises a vehicle which does not participate in the string receiving the string and vehicle data, comparing the roof value with the participation value, and determining based on the comparison whether the non-participating vehicle can join the string. Thereby, the non-participating vehicle joins the string, and upon joining the string repeatedly or continuously transmitting string and vehicle data including the roof value, and a position value representing a position in the string of the joining vehicle. Since the string and vehicle data is sent automatically, i.e. without any request from the non-participating vehicle, a simple, secure, and fully dynamic formation and maintenance of strings of platooning vehicles may be provided.

In some embodiments, the non-participating vehicle is a lead vehicle in a second string comprising at least one second string participating vehicle following the non-participating vehicle, the second string participating vehicle, upon the non-participating vehicle joining the first string, receiving the string and vehicle data from the joining vehicle, comparing the roof value with the position value of the joining vehicle, and determining based on the comparison whether the second string participating vehicle can join the first string. Hence sufficient information for the determination of following vehicles in the second string is provided without any request message or similar needing to be transferred. Thereby, the lead vehicle in the second string does need to communicate with, or be informed about other vehicles in the second string, during the joining process. This further simplifies the string handling.

Preferably, the method includes the non-participating vehicle determining whether it is following directly behind the last vehicle in the string. Thereby, the method may comprise the non-participating vehicle receiving from the last vehicle of the string data representative of an absolute position of the last vehicle in the string, the method further comprising determining an absolute position of the non-participating vehicle, determining by means of at least one sensor a distance to a vehicle in front of the non-participating vehicle, and determining, based on the absolute position of the last vehicle in the string, the absolute position of the non-participating vehicle, and the distance to the vehicle in front of the non-participating vehicle, whether the vehicle in front of the non-participating vehicle is the last vehicle in the string. This provides an effective way of determining that the vehicle in front of the non-participating vehicle is part of the string, i.e. that there is no vehicle not equipped for platooning between the non-participating vehicle and the string. The distance to the vehicle in front of the non-participating vehicle can be determined in any suitable manner, e.g. by a sensor, such as a radar sensor, on the non-participating vehicle, tags on the vehicles, driver confirmation, etc. In alternative embodiments, the determination whether the vehicle in front of the non-participating vehicle is the last vehicle in the string, may be done by comparing velocity and acceleration data in the wireless communication, to velocity and acceleration data determined by means of a sensor, such as a radar sensor. In further embodiments, the determination whether the vehicle in front of the non-participating vehicle is the last vehicle in the string, may be done by comparing the vehicle identity data in the string and vehicle data to data provided by an RFID (Radio Frequency Identification) tag on the vehicle in front of the non-participating vehicle.

In some embodiments, where the string is a first string, the method comprises a vehicle which does not participate in the string receiving the string and vehicle data, wherein the non-participating vehicle is a lead vehicle in a second string, the non-participating vehicle determining based on the roof value, the participation value and the number of vehicles in the second string whether the second string can join the first string. Thus, the non-participating vehicle has information about number of vehicles in the second string. Thereby, breaking up the second string may be avoided.

In advantageous embodiments, each of the vehicles in the string repeatedly or continuously transmitting string and vehicle data including the roof value, and a position value representing a position in the string of the respective vehicle. Thereby, the method may comprise a vehicle which does not participate in the string receiving the string and vehicle data transmitted by at least some of the vehicles in the string, and identifying the last vehicle in the string based on the position values in the string and vehicle data received from the at least some of the vehicles in the string. Where the string comprises a lead vehicle at the front of the string, the position value may represent a position in the string, counting from the lead vehicle, of the respective vehicle, wherein a vehicle which does not participate in the string may receive the string and vehicle data transmitted by at least some of the vehicles in the string, wherein the non-participating vehicle may identify the last vehicle in the string as the vehicle with the highest position value, or the non-participating vehicle may identify the participation value as the highest position value.

Thereby sufficient information may be provided to a non-participating vehicle for the determination whether it may join the string, without the need for any of the vehicles in the string to have any information about the current string except for the position value of the respective vehicle. For example, the last vehicle in the string does not need to have the information that it is the last vehicle in the string. Thereby a very simple information process is provided for the string handling. In some embodiments, it is confirmed that the non-participating vehicle is directly behind the vehicle with the highest position value in the string. This may be done similarly to as described above for determining whether the non-participating vehicle is directly behind the last vehicle in the string. For example, the confirmation may be done based on an absolute position of the vehicle with the highest position value in the string and vehicle data sets received, an absolute position of the non-participating vehicle, and distance information from a sensor. Alternatively, the determination that the non-participating vehicle is directly behind the vehicle with the highest position value in the string may be done by comparing velocity and acceleration data in the wireless communication, to velocity and acceleration data determined by means of a sensor. As a further alternative, the confirmation may be done by comparing the vehicle identity data in the string and vehicle data to data provided by an RFID (Radio Frequency Identification) tag on the vehicle in front of the non-participating vehicle.

The method may comprise a vehicle in the string adjusting, upon detecting that a vehicle ahead has left the string, its position value. Thereby, the string and vehicle data may be kept up to date, e.g. for a correct basis for a determination of a non-participating vehicle to join the string.

The string and vehicle data preferably includes string identification data. Thereby, it may be secured that information in the string handling communication is distinguishable from other wireless V2V communication in the surrounding, e.g. from other vehicle platooning operations.

The method may comprise reducing the roof value. The reason might be that the string is approaching an area, such as an urban area, where a shorter string is required for maintaining a safe platooning process. For example the lead vehicle of the string may enter a zone with increased tendency for braking, vehicle cut in, or lane changes. Advantageously, the method may comprise a receiving vehicle in the string receiving from a transmitting vehicle in the string, ahead of the receiving vehicle, the roof value. Thereby, the receiving vehicle may determine based on the roof value whether to leave the string. Where the string comprises a lead vehicle at the front of the string, the receiving vehicle may compare the roof value with a position value representing a position in the string, counting from the lead vehicle, of the receiving vehicle. Thereby the receiving vehicle may determine based on the comparison of the roof value with the position value whether to leave the string. Thus, such embodiments of the invention provide for a smooth manner of reducing the string when required, with a minimum of information exchange between vehicles in the string. Simply by adjusting the roof value, sufficient information is provided for vehicles in the string to determine whether to leave the string.

Preferably, where the string comprises a lead vehicle at the front of the string and a second vehicle following directly after the lead vehicle, the method comprises the second vehicle repeatedly or continuously transmitting, upon the lead vehicle leaving the string, string and vehicle data including the roof value, and a position value indicating that the second vehicle is at the front of the string. The position value may represent a position in the string counting from the lead vehicle. The position value indicating that the second vehicle is at the front of the string could be e.g. one. Thus, upon the lead vehicle leaving the string, the second vehicle in the string could assume the role of lead vehicle in the same string, or in a new string. Vehicles following the new lead vehicle may thereby update their respective string and vehicle data according to the updated string and vehicle data received from one or more vehicles in front of the respective vehicle. Thereby a simple and smooth manner of maintaining the string in the case of the lead vehicle leaving the string is obtained.

Preferably, where the string is a first string, the method comprises a vehicle repeatedly or continuously transmitting, upon leaving the first string, string and vehicle data including a roof value representing a maximum number of vehicles allowed in a second string, and a position value indicating that the vehicle is at the front of the second string. The position value may represent a position in the string counting from the lead vehicle. The position value indicating that the vehicle is at the front of the second string could be e.g. one. Thus, upon the vehicle leaving the string, the vehicle could assume the role of lead vehicle in a new string. Other vehicles may thereby join the new string, e.g. as described above. Thereby a simple and smooth manner of forming a new string in the case of a vehicle leaving the old string is obtained.

Preferably, where the string is a first string, the method comprises a receiving vehicle in the string repeatedly or continuously receiving from a transmitting vehicle in the string, ahead of the receiving vehicle, the roof value, the receiving vehicle repeatedly or continuously transmitting, upon detecting a termination of the reception of the roof value from the transmitting vehicle, string and vehicle data including a roof value representing a maximum number of vehicles allowed in a second string, and a position value indicating that the receiving vehicle is at the front of the second string. The position value may represent a position in the second string counting from the lead vehicle. The position value indicating that the vehicle is at the front of the second string could be e.g. one. Thus, upon the receiving vehicle detecting a termination of the reception of the roof value from the transmitting vehicle, the receiving vehicle could assume the role of lead vehicle in a new string. Other vehicles may thereby join the new string, e.g. as described above. Thereby a simple and smooth manner of forming a new string in the case of a transmission loss in the old string is obtained.

In some embodiments, where the roof value is a first roof value, the method comprises a further vehicle in the string repeatedly or continuously transmitting string and vehicle data including a second roof value representing a maximum number of vehicles allowed in the string. Thereby, a vehicle which does not participate in the string may receive the string and vehicle data, compare the lowest of the first and second roof values with the participation value, and determine based on the comparison whether the non-participating vehicle can join the string. In such embodiments vehicles in the string may transmit different roof values. The roof values may advantageously be adjusted in dependence on conditions that are individual for the respective vehicle.

The objects are also reached with a method for controlling at least one string, each string comprising a plurality of vehicles platooning by means of vehicle-to-vehicle communication, the method comprising a receiving vehicle in a string repeatedly or continuously receiving from a transmitting vehicle in the string, ahead of the receiving vehicle, a roof value representing a maximum number of vehicles allowed in the string.

The method may comprise reducing the roof value. The reason might be that the string is approaching an area, such as an urban area, where a shorter string is required for maintaining a safe platooning process. Thereby, the receiving vehicle may determine based on the roof value whether to leave the string. Where the string comprises a lead vehicle at the front of the string, the method may comprise the receiving vehicle comparing the roof value with a position value representing a position in the string, counting from the lead vehicle, of the receiving vehicle. The receiving vehicle may determine based on the comparison of the roof value with the position value whether to leave the string. Similarly to embodiments described above, embodiments of this method provides for a smooth manner of reducing the string when required, with a minimum of information exchange between vehicles in the string. Simply by adjusting the roof value, sufficient information is provided for vehicles in the string to determine whether to leave the string.

It should be noted that the roof value and/or adjustments thereof may originate from a vehicle in the string, such as the lead vehicle. The need to reduce the string, e.g. due to the string approaching an urban area, may be determined from map and positioning data, e.g. by means of the Global Positioning System (GPS). In some embodiments, a stationary unit could wirelessly provide the roof value, or restrictions thereof, to vehicles passing.

Advantageous embodiments are defined by the dependent claims 31-35.

The objects are also reached with a method according to any one of the claims 36-53. The objects are also reached with a computer program according to claim 54, a computer readable medium according to claim 55, a control unit according to claim 56, or a vehicle according to claim 57.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of vehicles during a first situation in which an embodiment of the invention is employed.

FIG. 2 is a diagram depicting steps in the embodiment employed in the situation in FIG. 1.

FIG. 3 and FIG. 5 are side views of vehicles during a second situation in which an embodiment of the invention is employed.

FIG. 4 is a diagram depicting steps in the embodiment employed in the situation in FIG. 3 and FIG. 5.

FIG. 6 and FIG. 7 are side views of vehicles during a third situation in which an embodiment of the invention is employed.

FIG. 8 is a diagram depicting steps in the embodiment employed in the situation in FIG. 6 and FIG. 7.

FIG. 9 and FIG. 10 are side views of vehicles during a fourth situation in which an embodiment of the invention is employed.

FIG. 11 is a diagram depicting a step in a further embodiment of the invention.

### DETAILED DESCRIPTION OF EXAMPLE EMBODIMENTS OF THE INVENTION

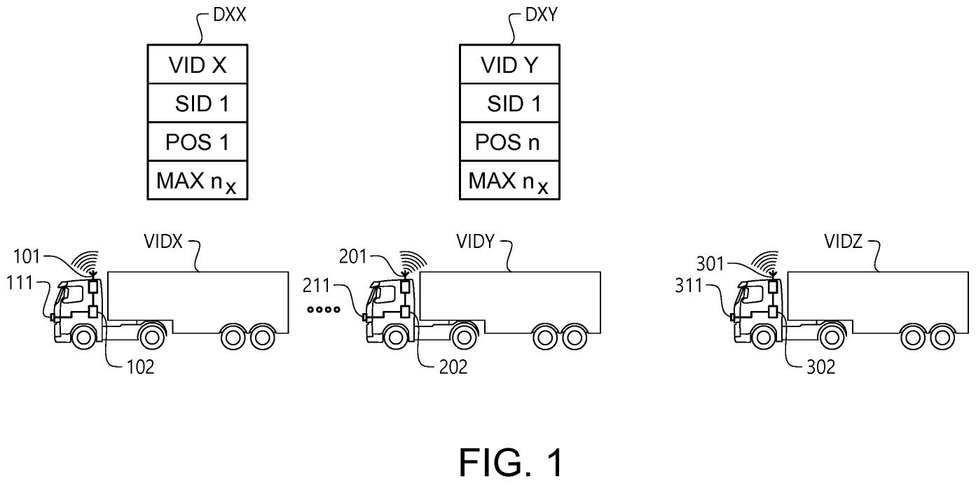

FIG. 1 shows what is herein referred to as a first vehicle VIDX, a second vehicle VIDY and a third vehicle VIDZ. In this example, the vehicles VIDX, VIDY, VIDZ are trucks with semitrailers. However, the invention is equally applicable to other types of vehicles, such as cars, buses and dump trucks.

Each of the vehicles VIDX, VIDY, VIDZ comprises equipment 101, 201, 301 for platooning, more specifically for Cooperative Adaptive Cruise Control (CACC), including means for wireless communication with a radio transmitter and a radio receiver for so called Vehicle-to-Vehicle (V2V) communication, and a data communication processing device which is arranged to communicate with a control unit 102, 202, 302 of a respective vehicle control system. Thereby, each of the vehicles VIDX, VIDY, VIDZ is adapted to transmit signals representative of the dimensions, velocity and acceleration of the respective vehicle to other vehicles comprising equipment for CACC. Further, each of the vehicles VIDX, VIDY, VIDZ is adapted to receive signals representative of the dimensions, velocity and acceleration of other vehicles comprising equipment for CACC, and to control the velocity and acceleration of the respective vehicle based on the received signals. It is understood that the exchange of information between the vehicles may include other, fewer or further parameters than those mentioned here.

In the situation depicted in FIG. 1, the first and second vehicles VIDX, VIDY form parts of a string SID1 comprising a plurality of vehicles platooning by means of vehicle-to-vehicle communication. The first vehicle VIDX is a lead vehicle of the string SID1, and is located at the front of the string. The second vehicle is the last vehicle in the string SID1. The string SID1 comprises a number of additional vehicles (not shown) between the first and second vehicles VIDX, VIDY. The string SID1 comprises n vehicles.

In the string each vehicle transmits wireless signals representative of the dimensions, velocity and the acceleration of the transmitting vehicle 2. The vehicle immediately behind the respective transmitting vehicle receives said wireless signals from the transmitting vehicle. Thereby, in this vehicle platooning process, each vehicle except the first vehicle VIDX is a receiving vehicle controlled to be at a relatively short distance from a transmitting vehicle immediately in front of the respective receiving vehicle.

The vehicle control system of the respective receiving vehicle controls brakes and a drivetrain of the receiving vehicle based on the wireless signals received from the respective transmitting vehicle. For example, if the transmitting vehicle brakes hard, signals representing the resulting deceleration will be received by the receiving vehicle which will based thereupon brake hard as well. CACC will in such a situation allow a considerably faster response by the receiving vehicle, compared to a vehicle control based on radar, laser or camera detection of the deceleration of the vehicle in front of the receiving vehicle.

It should be noted that in some embodiments, the vehicle control system of the respective receiving vehicle may control brakes and a drivetrain of the receiving vehicle based on the wireless signals received from a vehicle in front of the vehicle immediately in front of the respective receiving vehicle, e.g. from the vehicle at the front of the string, as an alternative to or in addition to wireless signals received from the vehicle immediately in front of the respective receiving vehicle.

In addition to the equipment for CACC, each vehicle VIDX, VIDY, VIDZ comprises a radar sensor 111, 211, 311 by means of which the presence of, and the distance to, an object in front of the respective vehicle may be determined. The radar sensor 111, 211, 311 provides means in addition to the CACC equipment for controlling the respective vehicle in relation to other vehicles. In alternative embodiments, the means in addition to the CACC equipment for controlling the respective vehicle in relation to other vehicles, could be provided by a laser sensor or a camera.

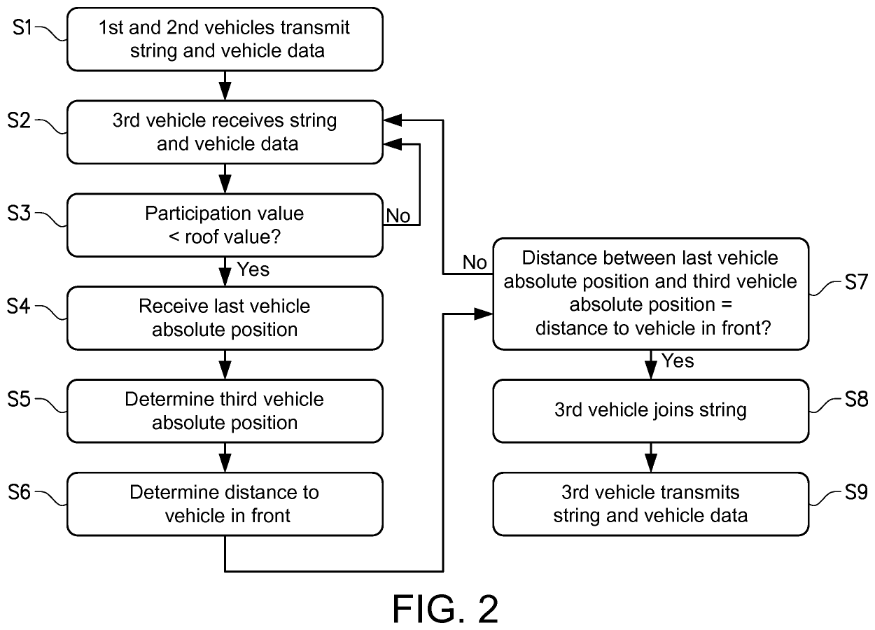

Reference is made also to FIG. 2. Each vehicle VIDX, VIDY in the string SID1 repeatedly or continuously transmits S1 string and vehicle data DXX, DXY by means of the CACC equipment 101, 201 and the control unit 102, 202. The string and vehicle data DXX, DXY may be sent e.g. at least once per second.

The string and vehicle data DXX, DXY includes a vehicle identity designation VIDX, VIDY, which is a unique identification designation for each vehicle. The string and vehicle data DXX, DXY further includes a string identity SID1, which is an identification designation for the string that the respective vehicle is currently in.

The string and vehicle data DXX, DXY also includes a roof value MAXnX representing a maximum number of vehicles allowed in the string SID1.

In addition, the string and vehicle data DXX, DXY includes a position value POS1, POSn representing a position in the string SID1 of the respective vehicle. More specifically, the position value POS1, POSn represents a position in the string SID1, counting from the lead vehicle VIDX, of the respective vehicle in the string. Thus, the position value POSn of the last vehicle VIDY forms what is herein referred to a participation value POSn indicative of the current number of vehicles in the string SID1.

In the situation in FIG. 1, the third vehicle VIDZ does not participate in the string SID1. The third VIDZ vehicle is driving behind the last vehicle VIDY of the string SID1. The third vehicle might have caught up with the string.

The third vehicle VIDZ receives S2 the string and vehicle data DXX, DXY from all vehicles in the string SID1 by means of the CACC equipment 301. It should be noted that in some embodiments, a vehicle outside the string may receive string and vehicle data from only the last vehicle in the string. In this embodiment, the third vehicle VIDZ identifies, by means of the control unit 302, the last vehicle VIDY in the string SID1 based on the position values POS1, POSn in the string and vehicle data received from the vehicles in the string SID1. More specifically, the third vehicle VIDZ identifies the last vehicle VIDY in the string SID1 as the vehicle with the highest position value POSn. The position value of the last vehicle VIDY in the string is the participation value POSn indicative of the current number of vehicles in the string SID1.

The third vehicle VIDY compares S3, by means of the control unit 302, the roof value

MAXnX with the participation value POSn. In this embodiment, the third vehicle determines S3 whether the participation value POSn is lower than the roof value MAXnX. If the participation value POSn is not lower than the roof value MAXnX, the third vehicle VIDZ determines to not join the string.

If the participation value POSn is lower than the roof value MAXnX, the third vehicle VIDZ determines whether the vehicle in front of the third vehicle VIDZ is the last vehicle VIDY in the string. For this, the third vehicle VIDZ receives S4 from the last vehicle VIDY of the string SID1 data representative of an absolute position of the last vehicle VIDY in the string. Such position data is included in the string and vehicle data DXX, DXY transmitted by each vehicle in the string. The third vehicle VIDZ also determines S5 the absolute position of the third vehicle VIDZ itself. These vehicle positions may be determined by any suitable means, e.g. by means of the Global Positioning System (GPS). In addition, the third vehicle VIDZ determines S6 by means of the radar sensor 311 a distance to a vehicle in front of the third vehicle VIDZ.

The third vehicle determines S7 whether the distance between the absolute position of the last vehicle VIDY and the absolute position of the third vehicle VIDZ is equal to the distance to the vehicle in front of the third vehicle VIDZ. If these distances are substantially the same, it is determined that the vehicle in front of the third vehicle VIDZ is the last vehicle VIDY of the string SID1. Thereby the third vehicle VIDZ determines to join S8 the string SID1. If said distances are unequal, it is determined that the vehicle in front of the third vehicle VIDZ is not the last vehicle VIDY of the string SID1. Thereby it is determined that the third vehicle is not following directly behind the last vehicle VIDY in the string SID1, and the third vehicle VIDZ determines to not join the string SID1.

It should be noted that the method may also comprise the third vehicle VIDZ determining whether it is in the same driving lane of the road as the last vehicle in the string SID1. This may be done e.g. by use of the radar sensor, any other suitable sensor, vehicle tags, and/or driver confirmation.

Upon joining the string SID1 the third vehicle VIDZ repeatedly or continuously transmits string and vehicle data including the roof value MAXnX, and a position value POSn+1 representing a position in the string of the third vehicle VIDZ. The third vehicle becomes the last vehicle in the string SID1. The position value POSn+1 transmitted by the third vehicle is one unit above the position value POSn transmitted by the second vehicle VIDY.

In some embodiments, vehicles in a string may transmit different roof values. For example, in the string depicted in FIG. 1, the first vehicle VIDX may transmit a first roof value MAXnX and the second vehicle VIDY may transmit a second roof value MAXnX2. Thereby, the third vehicle VIDZ may identify the lowest of the first and second roof values MAXnX, MAXnX2. Similar to what is mentioned above with reference to FIG. 1 and FIG. 2, the third vehicle may also identify the highest position value POSn transmitted from vehicles in the string. Thereby, the third vehicle VIDZ may compare the lowest roof value with the highest position value POSn and determine based on this comparison whether the third vehicle VIDZ can join the string. In some embodiments, behind the lead vehicle, each vehicle in the string includes in its string and vehicle data the roof value of the vehicle immediately in front of the respective vehicle. Thereby, where the roof values in the string differ, the last vehicle in the string will transmit the lowest roof value in the string.

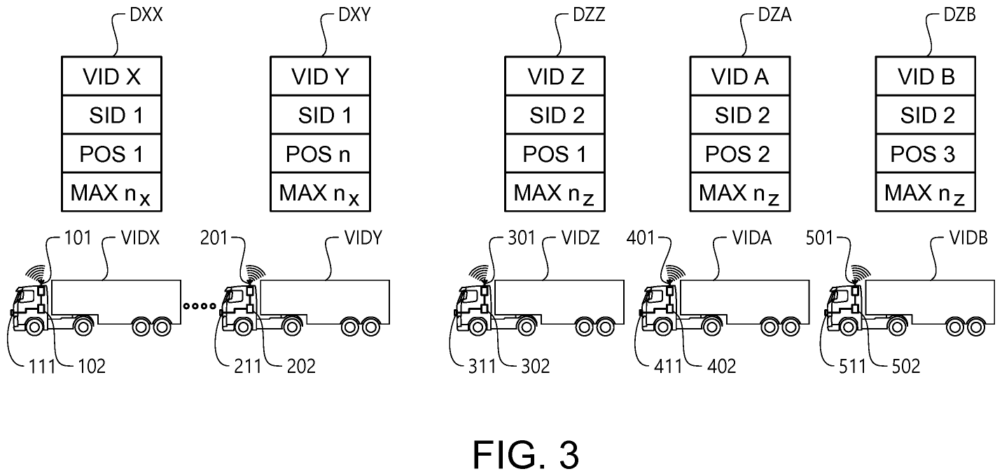

The vehicles in the string transmitting different roof values may be a result of the vehicles adjusting the respective roof values based on individual conditions for the vehicles. Such conditions may include capacity limitations of the equipment for the V2V communication. FIG. 3 depicts a situation which is similar to the situation depicted in FIG. 1 in that the first vehicle VIDX and the second vehicle VIDY are parts of a string SID1 as described with reference to FIG. 1. Here this string is referred to as a first string SID1. Differing from the situation in FIG. 1, in the situation in FIG. 3, the third vehicle VIDZ is a lead vehicle in a second string SID2 comprising a fourth vehicle VIDA following the third vehicle VIDZ. The second string SID2 also comprises a fifth vehicle VIDB following behind the fourth vehicle VIDA. The second string SID2 may be behind the first string SID1. The second string SID2 may have caught up with the first string SID1.

The platooning process of the second string SID2 is similar to the platooning process of the string described with reference to FIG. 1. Thus, each vehicle VIDZ, VIDA, VIDA in the second string SID2 repeatedly or continuously transmits string and vehicle data DZZ, DZA, DZB by means of the CACC equipment 301, 401, 501 and the control unit 302, 402, 502. The string and vehicle data DZZ, DZA, DZB includes a second roof value MAXnZ representing a maximum number of vehicles allowed in the second string SID2. In addition, the string and vehicle data DZZ, DZA, DZB includes a position value POS1, POS2, POS3 representing a position in the string SID1 of the respective vehicle.

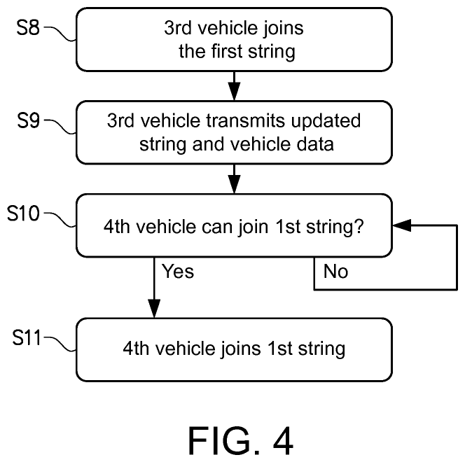

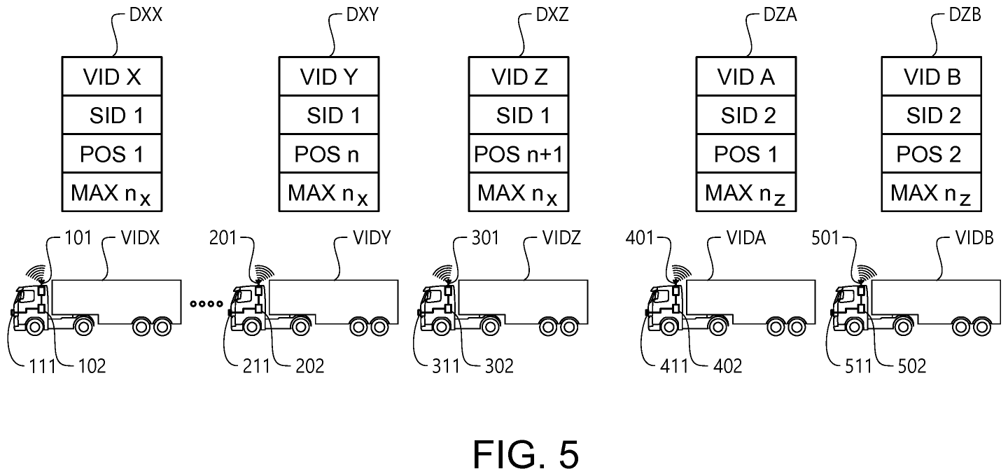

Reference is made also to FIG. 4 and FIG. 5. The third vehicle VIDZ joins S8 the first string SID1 upon a process as described above with reference to FIG. 2. Thereby, the third vehicle VIDZ leaves the second string SID2 by updating its string and vehicle data DXZ so that the roof value is the roof value MAXnX of the first string SID1, and the position value is the position POSn+1 of the third vehicle SID2 in the first string SID1. Upon joining the first string SID1 the third vehicle VIDZ repeatedly or continuously transmits the updated string and vehicle data DXZ. The third vehicle becomes the last vehicle in the first string SID1.

In addition, the fourth vehicle VIDA detects, by the updated string and vehicle data DXZ transmitted by the third vehicle VIDZ, that the third vehicle VIDZ has left the second string SID2. Thereupon, the fourth vehicle VIDA adjusts its position value POS1 to be one unit lower than before. In this example, the fourth vehicle thereby becomes the lead vehicle of the second string SID2. In addition, the fifth vehicle VIDB adjusts its position value POSn2 to be one unit lower than before.

Thereupon, the fourth vehicle determines S10 whether it may join the first string SID1. This is done by a process as described above with reference to FIG. 2. If it is determined that the fourth vehicle can join the first string, the fourth vehicle joins S11 the first string. Thereby, the fourth vehicle VIDZ leaves the second string SID2 by updating its string and vehicle data so that the roof value is the roof value MAXnX of the first string SID1, and the position value is the position POSn+2 of the fourth vehicle SID2 in the first string SID1.

Upon joining the first string SID1 the fourth vehicle VIDA repeatedly or continuously transmits the updated string and vehicle data. The fourth vehicle becomes the last vehicle in the first string SID1.

The processes of vehicles leaving the second string and joining the first string are repeated until all vehicles in the second string has joined the first string, or until the participation value of the first string is equal to the roof value of the first string, as in step S3 in FIG. 2. If it is determined that the fourth vehicle VIDA cannot join the first string, the determination whether the fourth vehicle can join the first string may continue. The fourth vehicle may eventually be allowed to join the first string, e.g. upon another vehicle leaving the first string as exemplified below. Alternatively, if it is determined that the fourth vehicle VIDA cannot join the first string, no further determination whether the fourth vehicle can join the first string is made.

In alternative embodiments, in a situation as depicted in FIG. 3, the third vehicle VIDZ is informed about the number of vehicles participating in the second string SID2. Thereby, the third vehicle VIDZ determines based on the roof value MAXnX of the first string SID1, the participation value POSn of the first string SID1 and the number of vehicles in the second string SID2 whether the second string can join the first string SID1. If it is determined that the second string can join the first string, the second string joins the first string and the string and vehicle data of all vehicles in the second string is updated. If it is determined that the second string cannot join the first string, the second string remains a separate string.

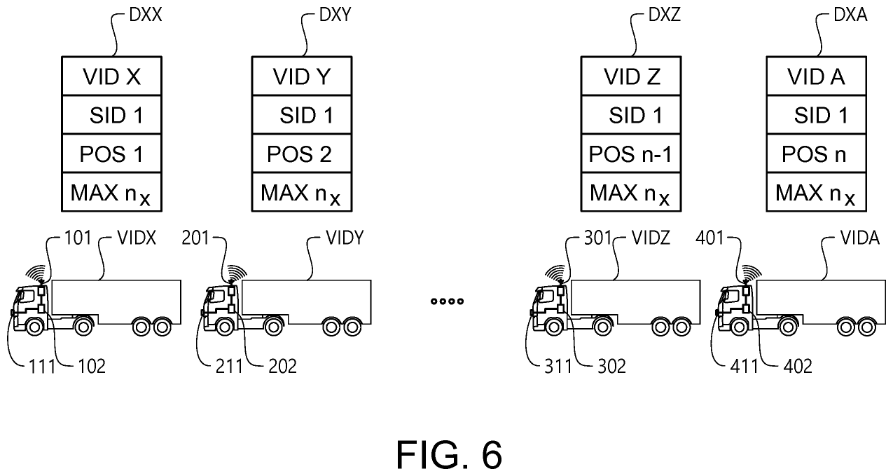

Reference is made to FIG. 6. A string SID1 includes a first vehicle VIDX, which is a lead vehicle at the front of the string. The string SID1 also includes a second vehicle VIDY following immediately behind the first vehicle. The string further includes a third vehicle VIDZ, and a fourth vehicle which follows immediately behind the third vehicle VIDZ and which is the last vehicle in the string. The string may include further vehicles between the second and third vehicles VIDY, VIDZ. The platooning method in the string is similar to what has been described above with reference to FIG. 1.

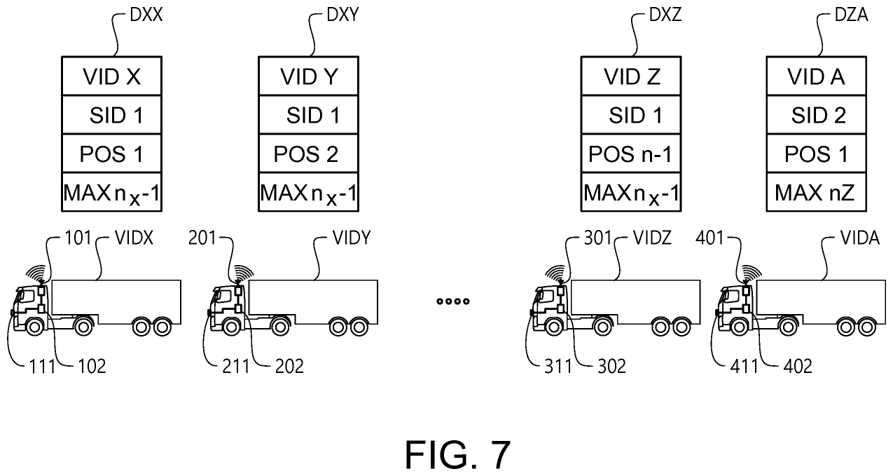

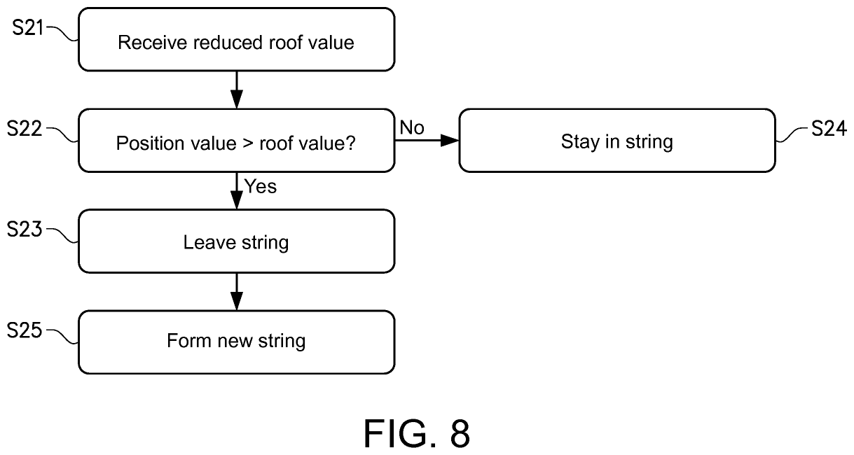

Reference is made also to FIG. 7 and FIG. 8. As can be seen in FIG. 7, in this example, the roof value MAXnX-1 is reduced by one unit. This reduction may be done by the lead vehicle VIDX. The reduction may be done for example based on a detected change in the driving conditions, e.g. the string entering an urbanized area.

Each of the vehicles VIDY, VIDZ, VIDA following the lead vehicle VIDX adjusts the roof value accordingly upon receiving S21 the reduced roof value from a preceding vehicle in the string. Thereupon, each vehicle VIDY, VIDZ, VIDA following the lead vehicle VIDX compares S22 the roof value MAXnX-1 with its respective position value POS2, POSn-1, POSn. Each vehicle VIDY, VIDZ, VIDA following the lead vehicle VIDX determines based on the comparison of the roof value MAXnX-1 with the position value POS2, POSn-1, POSn whether to leave the string SID1. If the position value POS2, POSn-1, POSn is higher than the roof value MAXnX-1, the vehicle leaves S23 the string. Otherwise the vehicle stays S24 in the string.

In the example in FIG. 7, the fourth vehicle VIDA, i.e. the last vehicle in the string, determines based on the comparison of the roof value MAXnX-1 with its position value to leave the string SID1. Thereby the fourth vehicle VIDA updates the string and vehicle data DZA which it transmits, so as to include an updated string identity denomination SID2, an updated roof value MAXnZ, and an updated positon value POS1. Thereby, the fourth vehicle forms S25 a new string SID2 in which it is the lead vehicle as indicated by the updated position value POS1. Further vehicles may join the new string with a process as described above with reference to FIG. 2.

A new string may be formed upon a vehicle leaving a string for other reasons than that in the example described with reference to FIG. 6-FIG. 8. For example, a vehicle may leave the string due to reducing its speed, or due to a connection in the platoon of the original string being lost, as exemplified below.

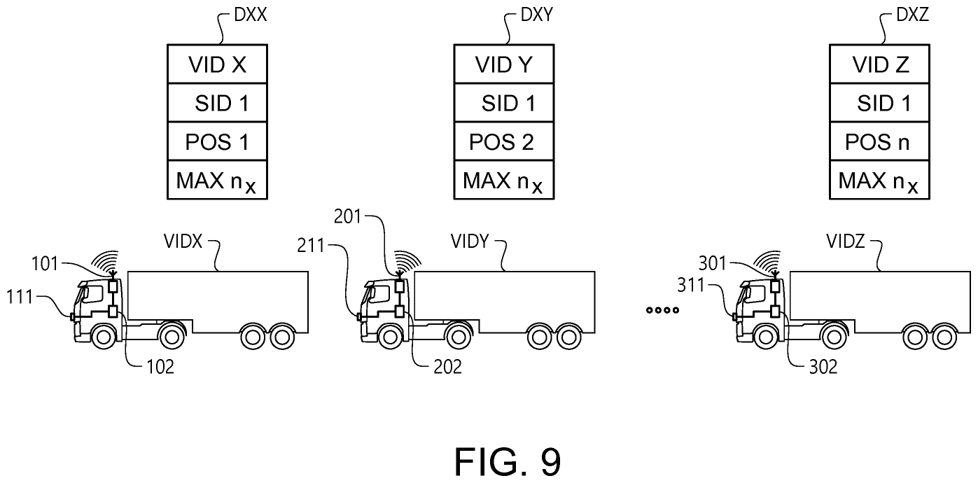

Reference is made to FIG. 9. A string SID1 includes a first vehicle VIDX, which is a lead vehicle at the front of the string. The string SID1 also includes a second vehicle VIDY following immediately behind the first vehicle. The string further includes a third vehicle VIDZ which is the last vehicle in the string. The string may include further vehicles between the second and third vehicles VIDY, VIDZ. The platooning method in the string is similar to what has been described above with reference to FIG. 1.

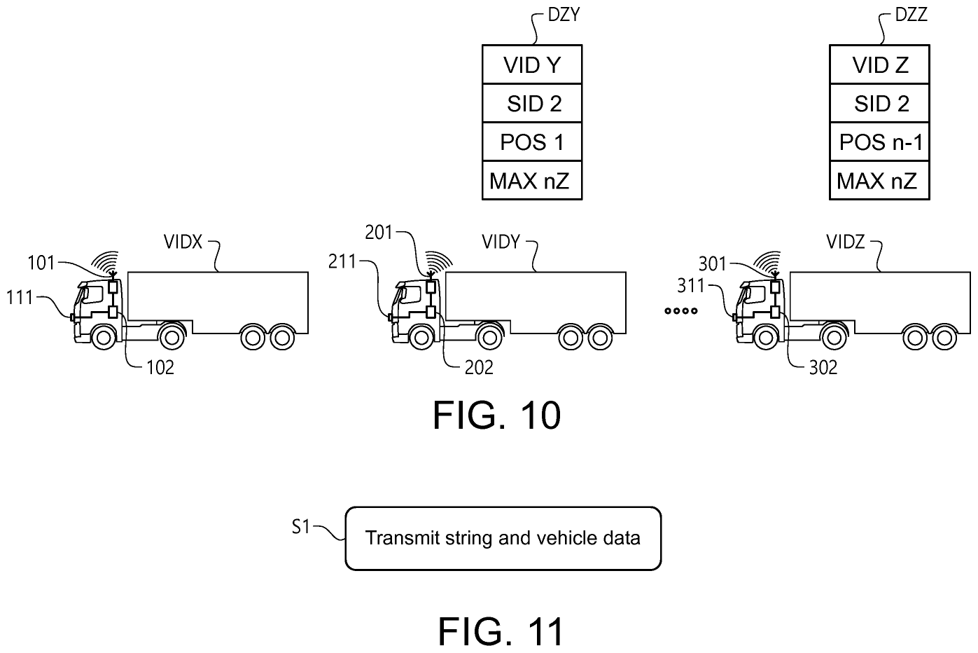

As depicted in FIG. 10, the first vehicle VIDX leaves the string SID1. The reason might be e.g. that the first vehicle exits the lane or the road, increases its speed, or simply terminates the transmission of the string and vehicle data DXX. Thereby the second vehicle VIDY updates the string and vehicle data DZY which it transmits, so as to include an updated string identity denomination SID2, an updated roof value MAXnZ, and an updated positon value POS1, e.g. one. Thereby, the second vehicle forms a new string SID2 in which it is the lead vehicle as indicated by the updated position value POS1.

Thereupon, each vehicle VIDZ following the lead vehicle VIDY updates, upon receiving updated string and vehicle data from a preceding vehicle, its respective string and vehicle data so as to include the updated string identity denomination SID2, the updated roof value MAXnZ, and an updated positon value POSn-1. The respective updated positon value POSn-1 is determined by adding one unit to the highest positon value received in combination with the updated string identity denomination SID2.

Thereupon, each vehicle VIDZ following the lead vehicle VIDY in the new string SID2 compares the updated roof value MAXnZ with its respective position value POSn-1, and determines based on the comparison of the roof value MAXnZ with the position value POSn-1 whether to leave the string SID1, similarly to what has been described above with reference to FIG. 8.

The procedure described with reference to FIG. 9-FIG. 10 may be used also in cases where a vehicle in a string, other than the lead vehicle, leaves the string, e.g. by exiting the lane or the road, or by terminating the transmission of the string and vehicle data. Thus, a vehicle that followed immediately behind the leaving vehicle may form a new string in which it is the lead vehicle. Thereupon, each vehicle following the new lead vehicle may update, upon receiving updated string and vehicle data from a preceding vehicle, its respective string and vehicle data. Thereupon, each vehicle following the lead vehicle may compare the updated roof value with its respective position value, and determine based on the comparison whether to leave the new string.

Alternatively, if a vehicle in a string, other than the lead vehicle, leaves the string, the vehicle that followed immediately behind the leaving vehicle may simply update its position value, e.g. by reducing it one unit, and remain in the string. Further following vehicles may also update their respective position values and remain in the string.

The procedure described with reference to FIG. 9-FIG. 10 may be used also in cases where a vehicle not equipped for vehicle not equipped for vehicle platooning enters between two vehicles in a string. Thus, a vehicle that follows immediately behind the entering non-equipped vehicle may form a new string in which it is the lead vehicle.

Further variations as possible within the scope of the claims. FIG. 11 depicts a step in a simple embodiment of an aspect of the invention. The step involves a vehicle in a string repeatedly or continuously transmitting S1 string and vehicle data including a roof value representing a maximum number of vehicles allowed in the string, and a participation value indicative of the current number of vehicles in the string.

It is to be understood that the present invention is not limited to the embodiments described above and illustrated in the drawings; rather, the skilled person will recognize that many changes and modifications may be made within the scope of the appended claims.

1.-57. (canceled)

58. A method for at least one string, each string comprising a plurality of vehicles platooning by means of vehicle-to-vehicle communication, the method comprising a vehicle (VIDY) in a string (SID1) repeatedly or continuously transmitting (S1) string and vehicle data including a roof value (MAXnX) representing a maximum number of vehicles allowed in the string, and a participation value (POSn) indicative of the current number of vehicles in the string (SID1), wherein a vehicle (VIDZ) which does not participate in the string receiving (S2) the string and vehicle data, comparing (S3) the roof value with the participation value, and determining based on the comparison whether the non-participating vehicle (VIDZ) can join (S8) the string, wherein the non-participating vehicle (VIDZ) joins (S8) the string (SID1), characterized by the non-participating vehicle (VIDZ), upon joining the string, repeatedly or continuously transmitting (S9) string and vehicle data including the roof value (MAXnX), and a position value (POSn+1) representing a position in the string of the joining vehicle (VIDZ).

59. A method according to claim 58, characterized in that the vehicle transmitting the string and vehicle data is the last vehicle (VIDY) in the string (SID1), and the participation value is a position value (POSn) representing a position in the string of the last vehicle in the string.

60. A method according to claim 58, wherein the string (SID1) comprises a lead vehicle (VIDX) at the front of the string, characterized in that the participation value (POSn) represents a position in the string, counting from the lead vehicle, of the last vehicle in the string.

61. A method according to claim 58, characterized in that the string and vehicle data (MAXnX, POSn) is sent at least once per second.

62. A method according to claim 58, wherein the string is a first string (SID1), characterized in that the non-participating vehicle (VIDZ) is a lead vehicle in a second string (SID2) comprising at least one second string participating vehicle (VIDA) following the non-participating vehicle (VIDZ), the second string participating vehicle (VIDA), upon the non-participating vehicle (VIDZ) joining (S8) the first string (SID1), receiving the string and vehicle data from the joining vehicle (VIDZ), comparing the roof value (MAXnX) with the position value (POSn+1) of the joining vehicle (VIDZ), and determining (S10) based on the comparison whether the second string participating vehicle (VIDA) can join the first string (SID1).

63. A method according to claim 58, characterized by the non-participating vehicle (VIDZ) determining (S4-S7) whether it is following directly behind the last vehicle (VIDY) in the string (SID1).

64. A method according to claim 63, characterized by the non-participating vehicle (VIDZ) receiving (S4) from the last vehicle (VIDY) of the string (SID1) data representative of an absolute position of the last vehicle in the string, the method further comprising determining (S5) an absolute position of the non-participating vehicle (VIDZ), determining (S6) by means of at least one sensor a distance to a vehicle in front of the non-participating vehicle (VIDZ), and determining (S7), based on the absolute position of the last vehicle (VIDY) in the string, the absolute position of the non-participating vehicle (VIDZ), and the distance to the vehicle in front of the non-participating vehicle (VIDZ), whether the vehicle in front of the non-participating vehicle (VIDZ) is the last vehicle (VIDY) in the string.

65. A method according to claim 58, wherein the string is a first string (SID1), characterized by a vehicle (VIDZ) which does not participate in the string receiving the string and vehicle data, wherein the non-participating vehicle (VIDZ) is a lead vehicle in a second string (SID2), the non-participating vehicle (VIDZ) determining based on the roof value (MAXnX), the participation value (POSn) and the number of vehicles in the second string (SID2) whether the second string can join the first string (SID1).

66. A method according to claim 58, characterized by each of the vehicles (VIDX, VIDY) in the string repeatedly or continuously transmitting string and vehicle data (DXX, DXY) including the roof value (MAXnX), and a position value (POS1, POSn) representing a position in the string of the respective vehicle.

67. A method according to claim 66, characterized by a vehicle (VIDZ) which does not participate in the string (SID1) receiving the string and vehicle data transmitted by at least some of the vehicles in the string, and identifying the last vehicle (VIDY) in the string based on the position values (POS1, POSn) in the string and vehicle data received from the at least some of the vehicles in the string.

68. A method according to claim 66, wherein the string (SID1) comprises a lead vehicle (VIDX) at the front of the string, characterized in that the position value (POS1, POSn) represents a position in the string, counting from the lead vehicle, of the respective vehicle, wherein a vehicle (VIDZ) which does not participate in the string (SID1) receives the string and vehicle data transmitted by at least some of the vehicles in the string, wherein the non-participating vehicle identifies the last vehicle (VIDY) in the string as the vehicle with the highest position value (POSn), or the non-participating vehicle identifies the participation value as the highest position value.

69. A method according to claim 66, characterized by a vehicle (VIDY) in the string (SID1) adjusting, upon detecting that a vehicle (VIDX) ahead has left the string (SID1), its position value (POS1).

70. A method according to claim 58, characterized in that the string and vehicle data includes string identification data (SID1).

71. A method according to claim 58, characterized by reducing the roof value (MAXnX-1).

72. A method according to claim 58, characterized by a receiving vehicle (VIDA) in the string receiving (S21) from a transmitting vehicle (VIDZ) in the string, ahead of the receiving vehicle, the roof value (MAXnX-1).

73. A method according to claim 72, characterized by the receiving vehicle (VIDA) determining (S22) based on the roof value (MAXnX-1) whether to leave the string.

74. A method according to claim 72, wherein the string (SID1) comprises a lead vehicle (VIDX) at the front of the string, characterized by the receiving vehicle (VIDA) comparing (S22) the roof value (MAXnX-1) with a position value (POSn) representing a position in the string, counting from the lead vehicle, of the receiving vehicle.

75. A method according to claim 74, characterized by the receiving vehicle (VIDZ) determining based on the comparison (S22) of the roof value (MAXnX-1) with the position value (POSn) whether to leave the string (SID1).

76. A method according to claim 58, the string comprising a lead vehicle (VIDX) at the front of the string and a second vehicle (VIDY) following directly after the lead vehicle, characterized by the second vehicle (VIDY) repeatedly or continuously transmitting, upon the lead vehicle (VIDX) leaving the string, string and vehicle data including the roof value (MAXnX), and a position value (POS1) indicating that the second vehicle (VIDY) is at the front of the string.

77. A method according to claim 58, where the string is a first string (SID1), characterized by a vehicle (VIDA) repeatedly or continuously transmitting (S25), upon leaving (S23) the first string, string and vehicle data including a roof value (MAXnZ) representing a maximum number of vehicles allowed in a second string (SID2), and a position value (POS1) indicating that the vehicle (VIDA) is at the front of the second string.

78. A method according to claim 58, where the string is a first string (SID1), characterized by a receiving vehicle (VIDY) in the string repeatedly or continuously receiving from a transmitting vehicle (VIDX) in the string, ahead of the receiving vehicle, the roof value (MAXnX), the receiving vehicle (VIDY) repeatedly or continuously transmitting, upon detecting a termination of the reception of the roof value from the transmitting vehicle (VIDX), string and vehicle data including a roof value (MAXnZ) representing a maximum number of vehicles allowed in a second string (SID2), and a position value (POS1) indicating that the receiving vehicle (VIDY) is at the front of the second string.

79. A method according to claim 58, where the roof value (MAXnX) is a first roof value, characterized by a further vehicle in the string (SID1) repeatedly or continuously transmitting string and vehicle data including a second roof value (MAXnX2) representing a maximum number of vehicles allowed in the string.

80. A method according to claim 79, characterized by a vehicle which does not participate in the string receiving the string and vehicle data, comparing the lowest of the first and second roof values (MAXnX, MAXnX2) with the participation value, and determining based on the comparison whether the non-participating vehicle (VIDZ) can join the string.

81. A method for controlling at least one string, each string comprising a plurality of vehicles platooning by means of vehicle-to-vehicle communication, the method comprising a receiving vehicle (VIDA) in a string (SID1) repeatedly or continuously receiving (S21) from a transmitting vehicle (VIDY) in the string, ahead of the receiving vehicle, a roof value (MAXnX) representing a maximum number of vehicles allowed in the string, the receiving vehicle (VIDA) repeatedly or continuously transmitting the roof value (MAXnX), characterized by the receiving vehicle (VIDA) repeatedly or continuously transmitting a participation value (POSn) representing a position in the string, counting from the lead vehicle, of the receiving vehicle.

82. A method according to claim 81, characterized by reducing the roof value (MAXnX-1).

83. A method according to claim 81, characterized by the receiving vehicle (VIDA) determining based on the roof value whether to leave the string (SID1).

84. A method according to claim 81, the string comprising a lead vehicle (VIDX) at the front of the string, characterized by the receiving vehicle comparing (S22) the roof value (MAXnX-1) with a position value (POSn) representing a position in the string, counting from the lead vehicle, of the receiving vehicle (VIDA).

85. A method according to claim 84, characterized by the receiving vehicle (VIDZ) determining based on the comparison of the roof value (MAXnX-1) with the position value (POSn) whether to leave (S23) the string (SID1).

86. A method according to claim 81, the string comprising a lead vehicle (VIDX) at the front of the string and a second vehicle (VIDY) following directly after the lead vehicle, characterized by the second vehicle (VIDY) repeatedly or continuously transmitting, upon the lead vehicle (VIDX) leaving the string, string and vehicle data including the roof value (MAXnX), and a position value (POSn) indicating that the second vehicle (VIDY) is at the front of the string.

87. A method according to claim 81, where the string is a first string (SID1), characterized by the receiving vehicle (VIDY) repeatedly or continuously transmitting, upon leaving the first string, string and vehicle data including a roof value (MAXnZ) representing a maximum number of vehicles allowed in a second string (1SID2), and a position value (POS1) indicating that the receiving vehicle (VIDY) is at the front of the second string (1SID2).

88. A method according to claim 81, where the string is a first string (SID1), characterized by the receiving vehicle (VIDY) repeatedly or continuously transmitting, upon detecting a termination of the reception of the roof value (VIDX) from the transmitting vehicle (VIDX), string and vehicle data including a roof value (MAXnZ) representing a maximum number of vehicles allowed in a second string (SID2), and a position value (POS1) indicating that the receiving vehicle (VIDY) is at the front of the second string.

89. A method according to claim 81, where the roof value (MAXnX) is a first roof value, characterized by the receiving vehicle repeatedly or continuously receiving from a further transmitting vehicle in the string, ahead of the receiving vehicle, a second roof value (MAXnX2) representing a maximum number of vehicles allowed in the string.

90. A method according to claim 89, characterized by the receiving vehicle (VIDA) determining based on the lowest of the first and second roof values (MAXnX, MAXnX2) whether to leave the string (SID1).

91. A method for a subject vehicle (VIDA) in a string comprising a plurality of vehicles platooning by means of vehicle-to-vehicle communication, repeatedly or continuously transmitting (S1) string and vehicle data including a roof value (MAXnX) representing a maximum number of vehicles allowed in the string, characterized in that the string and vehicle data includes a position value (POSn) representing a position in the string, counting from the lead vehicle, of the subject vehicle.

92. A method according to claim 91, characterized by receiving (S21) from a transmitting vehicle (VIDZ) in the string, ahead of the subject vehicle, the roof value (MAXnX-1).

93. A method according to claim 92, characterized by determining (S22) based on the roof value (MAXnX-1) whether to leave the string.

94. A method according to claim 91, wherein the string (SID1) comprises a lead vehicle (VIDX) at the front of the string, characterized by comparing (S22) the roof value (MAXnX) with the position value (POSn).

95. A method according to claim 94, characterized by determining based on the comparison (S22) of the roof value (MAXnX-1) with the position value (POSn) whether to leave the string (SID1).
